(19) United States
(12) Patent Application Publication
(10) Pub. No.: US 2008/0284586 A1
(43) Pub. Date: Nov. 20, 2008

(54) PORTABLE ELECTRONIC DEVICE AND METHOD FOR DETACHABLY ATTACHING THE SAME USING MAGNETIC ATTACHMENT DEVICE

(75) Inventor: Ching-Shan Chang, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: APPRO TECHNOLOGY INC., Taipei County (TW)

(21) Appl. No.: 11/748,494

(22) Filed: May 15, 2007

(51) Int. Cl. G06F 13/00

(52) U.S. Cl. 340/539.11

(57) ABSTRACT

A portable electronic device for both vehicle and home use is provided. The portable electronic device includes a magnetic attachment device having a magnetic element. Another magnetic element is disposed on the support inside the vehicle or home. When the portable electronic device is placed on the support, the controller in the electronic device may be activated in response to the interaction between the first and second magnetic elements and generates a controlling signal to operate the electronic elements in the electronic device. The controller may be deactivated in response to separation of the first magnetic element from the second magnetic element when the portable electronic device is detached from the support.

### BACKGROUND OF THE INVENTION

1. Field of Invention

The present invention relates to a portable electronic device for vehicle and home use, and more particularly, the present invention relates to a portable electronic device with a magnetic attachment device, and a method for detachably attaching the portable device on a support inside a vehicle and home.

2. Description of Related Art

As the time advances, various electronic devices appear on the market and electronic devices are developed towards being multi-functional, highly integrated to attract consumers and serve as an all-in-one device. In the meantime, to meet the requirements of portability and easy use, besides the miniature design of hardware, software and operation connector design is also a key element, so as to provide user the flexibility to use various functions of products.

At present, most of the home electronic devices on the market, such as multimedia audio/video device for watching TV, playing music and movies, or video recording and device for surveillance, video recording, recorded data reproduction or playback and the alike can be used in vehicle, so that driver and passenger can use various functions while in the vehicle. Examples of vehicle electronic products include GPS (Global Positioning System), radar detector, speeding alarm and backing alarm, and the like. For anti-theft security, vehicle electronic devices are usually locked onto the body of the vehicle using a lock, and user can't easily remove them. Therefore users can't use the vehicle electronic devices at home or elsewhere. In the meantime, since users have to manually start these electronic devices, for example turn on the power switch and the recording switch of a video recorder before recording can be started. However, in a case when the user inadvertently forgets to perform the above procedures, if any accident occurs, the scene of such an event cannot be recorded. Therefore, it is highly desirable to resolve the defects described above.

### SUMMARY OF THE INVENTION

The present invention provides an electronic device which can be detachably attached inside a vehicle as a vehicle electronic device, and can be detached from the vehicle and used at home as a home electronic device.

The present invention provides an electronic device comprising a magnetic attachment device, which may used for detachably fixing the electronic device inside a vehicle or home. The operation of the electronic device may be automatically activated.

The present invention provides an electronic device comprising a magnetic attachment device, which can be operated without manually activating the electronic device.

The present invention provides an electronic device suitable for both vehicle and home use. The electronic device includes a magnetic attachment device and a body. The magnetic attachment device comprises a magnetic element disposed in a base of the electronic device. The magnetic element is suitable to react to a magnetic element attached to a support inside the vehicle and home. The body includes a housing, a controller and a plurality of electronic components. The reactions between the two magnetic elements activate the controller to generate a control signal to initiate the operation of the electronic components of the electronic device.

The present invention provides a method using a magnetic attachment device suitable for detachably attaching electronic device inside a vehicle or home. The magnetic attachment device includes a magnetic element disposed on a base of the electronic device. The magnetic element is suitable for interacting with another magnetic element disposed on a support inside the vehicle or home. The interaction of the two magnetic elements may activate the controller inside the electronic device to generate a control signal, which may be used to operate the electronic elements of the electronic device. On the other hand, when the electronic device is detached or separated from the support by separating the magnetic element on the base of the electronic device from the magnetic element disposed on the support, the control signal is deactivated.

In an embodiment of the present invention, the electronic components operated by the control signal includes at least one of an image sensor, a position detector, a driving logger, a radar detector, a global positioning system (GPS) such as a satellite navigator, a video recorder and an audio/video player.

In an embodiment of the present invention, the electronic device includes a power jack for receiving a vehicle or home power supply.

In an embodiment of the present invention, the electronic device includes at least an input/output (I/O) interface unit for receiving an input signal or transmitting an output signal. In addition, the I/O port unit includes, for example, a card reader, a bus port and an audio/video port.

Since the control signal generated in response to the interaction between the two magnetic elements is used to activate the controller of the electronic device, therefore the electronic components need not be manually activated. When a detachable electronic device is detached from the support, the control signal is deactivated. Therefore, the electronic device need not be manually turned off. Thus, the electronic device of the present invention provides greater convenience to the user.

The accompanying drawings are included to provide a further understanding of the invention, and are incorporated in and constitute a part of this specification. The drawings illustrate embodiments of the invention and, together with the description, serve to explain the principles of the invention.

### BRIEF DESCRIPTION OF THE DRAWINGS

FIG. 1 is a schematic diagram of an electronic device according to an embodiment of the present invention.

FIG. 2 is a schematic diagram of an electronic device according to another embodiment of the present invention.

FIG. 3 is a schematic diagram of an electronic device according to another embodiment of the present invention.

FIG. 4 is a schematic diagram of an electronic device for use inside a vehicle according to an embodiment of the present invention.

### DESCRIPTION OF EMBODIMENTS

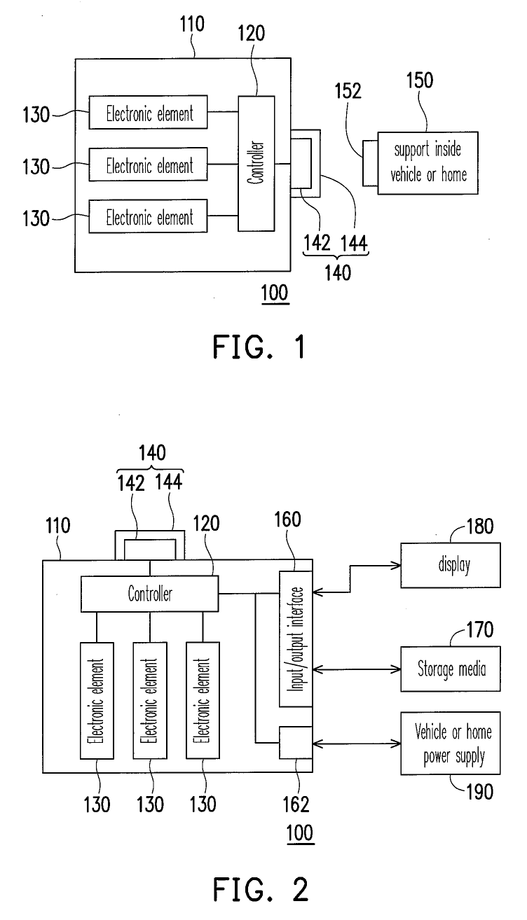

FIG. 1 is a schematic diagram of an electronic device according to an embodiment of the present invention. FIG. 2 is a schematic diagram of an electronic device according to another embodiment of the present invention. The present embodiment presents the elements of the electronic device 100 and connection relationship thereof using block diagram, without taking into consideration of the appearance of the electronic device 100 and the functions of the electronic components 130, the controller 120, and the like. Therefore, the teachings of the present invention may be also applied on any other portable electronic products to achieve the purpose of the present invention. In addition, in the present embodiment, the support 150 is only used as a part of the description in conjunction with the drawings. The support 150 is fixed on the vehicle body or on the wall or object inside the home, without taking the shape or fixing method of the support 150 inside the vehicle or home into consideration. Therefore the embodiments described herein are not intended to limit the scope of the present invention.

Referring to FIG. 1, the electronic device 100 includes a magnetic attachment device 140 disposed on a body 110 thereof. The magnetic attachment device 140 comprises a magnetic element 142 and a base 144. The base 144 is comprised of, for example, a tenon retainer or a groove retainer which corresponds to a shape of the connector of the support 150 inside a vehicle or home. The magnetic element 142 may be coupled to a magnetic element 152 attached on the support 150 by magnetic attraction, so that the user may easily detachably attach the electronic device on the support 150 inside the vehicle or home. In addition, the base 144 comprises a space for housing or holding the magnetic element 142. The magnetic element 142 comprises, for example, a magnet or a magnetic conductive device. The magnetic element 152 comprises, for example, a magnet or a magnetic conductive device. The two magnetic elements 142, 152 may attract or repel each other due to the magnetic attraction or repulsion. According to an embodiment of the present invention, when the portable electronic device 100 is placed on the support 150 inside the vehicle or home, the magnetic interaction between the two magnetic elements 142 and 152 may be used to generate a control signal, which may be used to activate the electronic elements of the electronic device, and therefore users need to manually activate the electronic device 100.

More specifically, when the electronic device 100 of the present invention is attached onto the support 150 inside the vehicle, the pre-set function can be automatically activated by merely attaching the electronic device 100 to the magnetic element 152 attached on the support 150 inside the vehicle. On the other hand, when the electronic device 100 is detached from the support 150 inside the vehicle, the separation of the magnetic element 142 from the magnetic element 152 may disable or deactivate the controller 120 and the pre-set function of the electronic device 100 may be automatically turned off. For example, when the electronic device 100 is attached on the support 150 inside the vehicle, surveillance system of the vehicle may be automatically activated to record the conditions of front side, rear side, left and right sides of the vehicle, or GPS, radar detector, speeding alarm and/or backing alarm functions may be automatically activated and provide the related information to the driver.

In the present embodiment, the electronic device 100 includes a controller 120 and a plurality of electronic elements 130. The electronic device 100 is disposed in the body 110, and can be operated independently or integrated into a multifunctional electronic product. The magnetic interaction between the two magnetic elements 142 and 152 may activate the controller 120 to generate a control signal to operate the electronic elements 130. For example, the controller 120 may comprise a magnetic sensing circuit (not shown) for sensing a magnetic force between the two magnetic elements 142 and 152, and thereby activate or deactivate the controller 120. Alternatively, the controller 120 may comprise, for example, a displacement sensing circuit (not shown) for sensing a displacement between the two magnetic elements 142 and 152, and thereby activates or deactivates the controller 120.

As shown in FIG. 1, a plurality of the electronic elements 130 are electrically connected to the controller 120, and the controller 120 activates the electronic elements 130 to perform the intended functions respectively. One of the electronic elements 130 includes, for example, an image sensor or a video recorder that can capture images. And the captured image can be stored in a hard drive or other storage media in video file or still image file format. In addition, the electronic elements 130 include, for example, a position detector, a driving logger, a radar detector and/or a GPS, and all the driving log data, detection record and/or navigation information can be stored in storage media such as hard drive, memory card, CD and etc.

Furthermore, the electronic elements 130 include, for example, audio/video player for reading data stored in hard drive, memory card or CD to reproduce the video data for user to view. FIG. 2 illustrates an electronic device according to another embodiment of the present invention, which includes at least an input/output port unit 160 such as a card reader, a bus port and/or AV (audio/video) port for receiving an input signal or outputting an output signal. Thus, the reproduced video can be copied into another storage media 170 or displayed on a monitor through an external connection method.

According to an embodiment of the present invention, the electronic device 100, besides being powered by a battery power, may also be equipped with a power jack 162 that can be connected to a vehicle or home power supply 190. Thus, as described above, the electronic device 100 is portable and may be used both inside a vehicle and home. Likewise, when the user returns home, the electronic device 100 may be attached on the support 150 at home, in doing so, the pre-set function is automatically activated. Therefore, the electronic device 100 can be portable and can be conveniently used both at home and inside the vehicle.

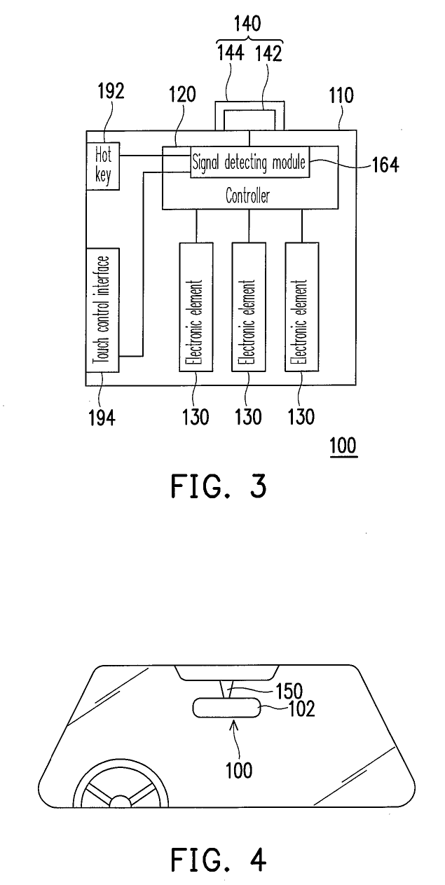

FIG. 3 is a view of an electronic device according to another embodiment of the present invention, which is similar to the embodiments described above except for the additional function of manually activating other functions to further personalize the settings inside vehicle, at home, outdoor, in office or in public transit system. For example, the controller 120 has a signal detecting module 164 used to detect whether a switch signal is sent via the magnetic attachment device 140 or from other sources. If the switch signal is sent via the magnetic attachment device 140, then the related automatic activated pre-set functions is turned on/off. If the switch signal is sent from other sources such as button, hotkey 192 or touch control interface 194 and etc, then the setting related to manual activated other functions is turned on/off. Thus, under manual mode, the automatic activated pre-set function will not be activated.

FIG. 4 is a schematic diagram of an in-vehicle configuration of the electronic device according to an embodiment of the present invention. The electronic device 100 may be, for example, housed in the interior rearview mirror body 102, and the support of the interior rearview mirror may serve as the support 150. The magnetic attachment device 140 in FIG. 1 is disposed on the back side of the interior rearview mirror body 102 (not shown in FIG. 3). The interior rearview mirror housing the electronic device 100 may be attached on the support 150 of the interior rearview mirror. The front of the interior rearview mirror body 102 has a mirror for driver to view the back of the vehicle. The operation of the internal electronic elements and controller are described with reference to FIG. 1 and FIG. 2 above, and therefore will not be repeated again. Similarly, the electronic device 100 may also be used at home to watch TV, record programs, play movies/music or used as camcorder. Although the said functions are not illustrated with drawings, however those skilled in art would understand such applications of the present invention, which shall also be construed to be within the scope of the present invention.

As described above, in the method for detachably attaching the electronic device, the magnetic attachment device of the electronic device can interact with the magnetic element fixed a support inside a vehicle or home. The magnetic interaction between the two magnetic elements activates the controller of the electronic device to generate a control signal to automatically operate the electronic device.

Since the control signal generated by the controller of the electronic device of the present invention is used to operate the electronic elements of the electronic device, and therefore the electronic components in the electronic device need not be activated manually. When the electronic device is detached from the support inside the vehicle or home, the separation of the magnetic elements may inactivate the controller of the electronic device, and the electronic elements in the electronic device may be turned off. The electronic device can be automatically turned off upon detaching the electronic device from the support, and therefore this can replace the use manually operating the switch or button to operate the electronic device. Moreover, the electronic device can be portable and may be used as a regular vehicle or home electronic device and can be quickly attached or detached from the support without requiring screws or other complicated fasteners or fixing devices.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A portable electronic device, suitable for detachably attaching on a support inside a vehicle or home, comprising:
a magnetic attachment device, comprising a first magnetic element and a base, wherein the base comprises a space to accommodate the magnetic element, and wherein the magnetic element is suitable for interacting with a second magnetic element disposed on the support inside the vehicle or home; and
a body, comprising a housing, a controller and a plurality of electronic elements, wherein the controller generates a control signal in response to the interaction between the first and second magnetic elements to operate the electronic elements.

2. The portable electronic device of claim 1, wherein the electronic elements comprises at least one of an image sensor, a location detector, a driving logger, a radar detector, a satellite navigator, a video camera and a video/audio player.

3. The portable electronic device of claim 1, wherein the controller has a magnetic sensing circuit for sensing a magnetic force between the first and second magnetic elements.

4. The portable electronic device of claim 1, wherein the controller comprises a displacement sensing circuit for sensing a displacement between the first and second magnetic elements.

5. The portable electronic device of claim 1, wherein the controller comprises a signal detecting module for detecting whether a switch signal is sent in via the magnetic attachment device.

6. The portable electronic device of claim 1, wherein the housing comprises an interior rearview mirror body, and the magnetic attachment device is disposed on the back of the interior rearview mirror body.

7. The portable electronic device of claim 1, wherein the body comprises a power jack for receiving a vehicle or home power supply.

8. The portable electronic device of claim 1, wherein the body comprises at least an input/output interface unit for receiving an input signal or transmitting an output signal.

9. The portable electronic device of claim 8, wherein the input/output interface unit comprises at least one of a card reader, a bus port and a video/audio port.

10. A method for detachably attaching an electronic device on a support inside a vehicle or home, comprising:
disposing a first magnetic element in a base of the electronic device;
disposing a second magnetic element on the support inside the vehicle or home;
placing the electronic device on the support, wherein a controller in the electronic device may be activated and generates a control signal in response to interaction between the first and second magnetic elements to operate at least one electronic element in the electronic device.

11. The method of claim 10, wherein the electronic element comprises at one of the image sensor, location detector, driving logger, radar detector, GPS, video camera and video/audio player.

12. The method of claim 10, wherein the controller of the electronic device is deactivated when the electronic device is detached from the support by separating the first magnetic element from the second magnetic element.
